(19) United States
(12) Patent Application Publication
(10) Pub. No.: US 2018/0066703 A1
(43) Pub. Date: Mar. 8, 2018

(54) ELECTRIC POWER GENERATION AND BRAKE DEVICE

(71) Applicant: Yuan-Kwei Tzeng, Miaoli County (TW)

(72) Inventor: Yuan-Kwei Tzeng, Miaoli County (TW)

(21) Appl. No.: 15/802,448

(22) Filed: Nov. 2, 2017

Related U.S. Application Data
(63) Continuation of application No. 14/603,045, filed on Jan. 22, 2015.

(51) Int. Cl. F16C 32/04; H02K 7/18; H02K 1/14; H02K 21/22; H02K 7/106; H02K 16/04; H02K 29/03

(52) U.S. Cl. CPC F16C 32/0497; H02K 7/1846; H02K 1/146; H02K 29/03; H02K 11/33; H02K 7/106; H02K 16/04; H02K 21/22

(57) ABSTRACT

An electric power generation and brake device disposed on a shaft includes: a wheel, a stator unit and a brake unit; the wheel comprising: an outer ring disposed around an edge of the wheel, an inner ring on the wheel and configured between the outer ring and an axis of the wheel, and a plurality of permanent magnets configured on one surface of the outer ring; the stator unit, comprising: a stator body, a plurality of first serrated portions disposed around an outer peripheral surface of the stator body, and a plurality of electric generating coils; the brake unit, comprising: a brake body fixed on the shaft or the stator body and configured between the inner ring and the axis of the wheel, a plurality of second serrated portions, and a plurality of brake coils; with the arrangement to resist vibration and reduce noise.

### CROSS REFERENCE TO RELATED APPLICATIONS

This application is a continuation application of and claims priority to the U.S. patent application Ser. No. 14/603,045 filed Jan. 22, 2015, the entire contents of which are incorporated herein by reference.

### BACKGROUND

1. Technical Field

The present invention relates to an electric power generation device, and more particularly to the electric power generation and brake device capable of resisting vibration to reduce electromagnetic noises.

2. Description of Related Art

With reference to FIG. 1 for a conventional power generation device 1, a power generator unit 3 is provided for generating alternating current continuously by rotating a wheel 2, and a rectifier 4 is provided for converting the alternating current into direct current, and then the direct current is supplied to a control panel 5. However, the control panel 5 requires a small amount of electric power for operation, so that a high power resistor 6 is used to consume the remaining electric power, and thus causing an issue of wasting power.

In addition, the conventional power generation device 1 adopts magnets of the wheel 2 and serrated portions of the power generator unit 3 which are not configured in pairs to reduce the significance of cogging torques, and thus the distribution of the internal torques is not uniform and vibrations are produced in the rotation direction easily. Therefore, the power generation device 1 may be damaged easily and may produce electromagnetic noises.

Therefore, it is a main subject of the present invention which develops a power generation device to achieve the effects of supplying the required electric power and electromagnetic resistance, as well as avoiding unnecessary waste of power, resisting vibration, and reducing electromagnetic noise.

### SUMMARY OF THE INVENTION

In view of the aforementioned problems of the prior art, it is a primary objective of the present invention which provides an electric power generation and brake device to overcome the problem of wasting power, resist vibration, and reduce electromagnetic noise.

To achieve the aforementioned and other objectives, the present invention provides an electric power generation and brake device disposed on a shaft and comprising a wheel, a stator unit, and a brake unit.

The wheel is movably and axially installed to the shaft, and the wheel comprises: an outer ring disposed around the edge of the wheel; an inner ring disposed coaxially with the outer ring on the wheel, and configured between the outer ring and an axis of the wheel; and a plurality of permanent magnets configured on one surface of the outer ring and facing the axis of the wheel.

The stator unit comprises a stator body fixedly disposed on the shaft; a plurality of first serrated portions, disposed around an outer peripheral surface of the stator body and facing the permanent magnets; and a plurality of electric generating coils, wound around the first serrated portions.

The brake unit comprises: a brake body fixed on the shaft or the stator body, configured between the inner ring and the axis of the wheel; a plurality of second serrated portions, disposed around an outer peripheral surface of the brake body and facing the inner ring; and a plurality of brake coils, wound around the second serrated portions.

In addition, in the aforementioned electric power generation and brake device, “the wheel, the stator unit and the brake unit” are configured in a base of a pedal exercise apparatus; the pedal exercise apparatus comprises a pedal unit in the base, and the wheel is driven by a driving member of the pedal unit to rotate on the shaft; the electric generating coils are caused, through rotation of the permanent magnets of the wheel relative to the stator unit, to generate an electric current; and the current generated causes, by an external operation, the brake coils of the brake unit to receive at least a part of the electric current to further cause a force for actuating the wheel.

In the aforementioned electric power generation and brake device, both of the outer ring and the inner ring are formed from extending a wheel body of the wheel, and the first serrated portions are accommodated between the outer ring and the inner ring.

In the aforementioned electric power generation and brake device, the wheel comprises a plurality of through holes between the outer ring and the inner ring that correspond to the electric generating coils.

In the aforementioned electric power generation and brake device, the stator body is provided with a plurality of through holes between the axis and the first serrated portions.

In the aforementioned electric power generation and brake device, the through holes of the stator body correspond to the brake coils.

In the aforementioned electric power generation and brake device, further comprising: a rectifier unit, electrically connected to the stator unit, converting an alternating current generated by the stator unit to a direct current, wherein, when the wheel rotates, the permanent magnets rotate with respect to the stator unit to generate the alternating current; a control panel, electrically connected to the rectifier unit to receive the direct current; a waveform generating unit, electrically connected to the control panel to receive the direct current, generating an inverted torque input signal according to an external operation on the control panel; and a DC power regulator unit, electrically connected to the waveform generating unit to receive the direct current and the inverted torque input signal, further electrically connected to the brake coils of the brake unit to transmit a regulatory direct current regulating under the inverted torque input signal to the brake coils.

In the aforementioned electric power generation and brake device, the permanent magnets of the wheel have a total of 12 magnetic poles, and the stator unit has a total of 37 first serrated portions.

In the aforementioned electric power generation and brake device, the second serrated portions of the brake unit have a total of 18 second serrated portions.

In the aforementioned electric power generation and brake device, the second serrated portions are configured on the outer peripheral surface of the brake body and are symmetrically arranged relative to a center of the brake body.

In summation, the electric power generation and brake device of the present invention has the function of generating both electric power and electromagnetic resistance and achieves the effects of avoiding unnecessary waste of power and generating uniform and symmetric reverse torques to resist vibration, no torque ripples or magnetic field interference is caused, so as to reduce electromagnetic noise.

### BRIEF DESCRIPTION OF THE DRAWINGS

FIG. 1 is a schematic view of a conventional power generation device;

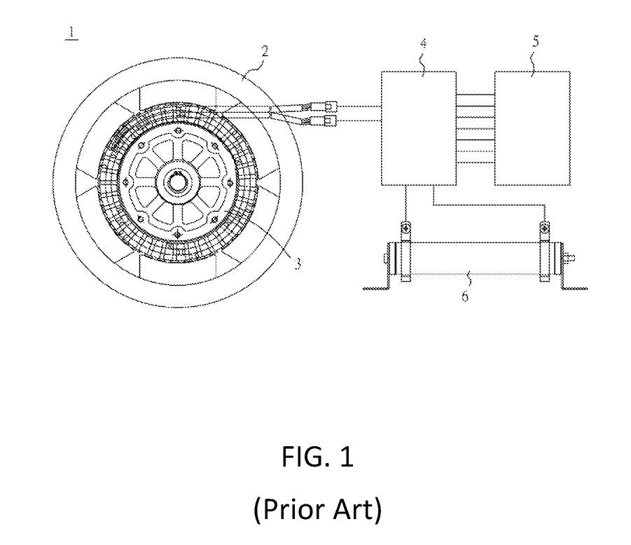

FIG. 2 is a schematic view of an electric power generation and brake device in accordance with a first preferred embodiment of the present invention;

FIG. 3 is a schematic view of an electric power generation and brake device installed to a pedal fitness equipment in accordance with the present invention;

FIG. 4 is a partial cross-sectional view of an electric power generation and brake device in accordance with the first preferred embodiment of the present invention;

FIG. 5 is a perspective view of a stator unit and a brake unit of an electric power generation and brake device combined with each other in accordance with the present invention;

FIG. 6 is a front view of a stator unit and a brake unit of an electric power generation and brake device combined with each other in accordance with the present invention; and

FIG. 7 is a schematic view of an electric power generation and brake device in accordance with a second preferred embodiment of the present invention.

### DESCRIPTION OF THE INVENTION

The technical characteristics, contents, advantages and effects of the present invention will become apparent from the following detailed description taken with the accompanying drawing.

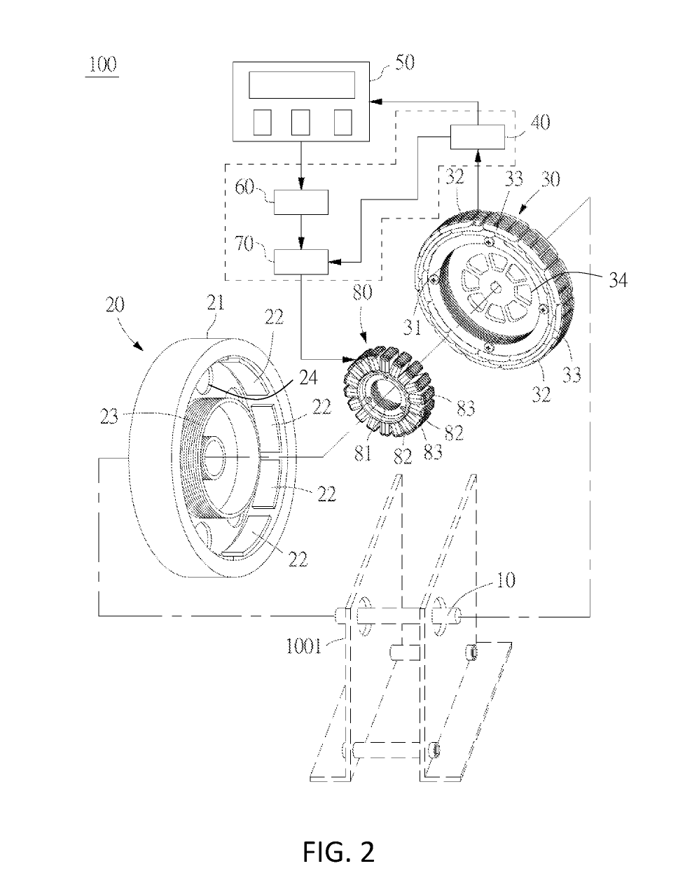

With reference to FIG. 2 for a schematic view of an electric power generation and brake device 100 of the present invention, the electric power generation and brake device 100 comprises a shaft 10, a wheel 20, a stator unit 30, a rectifier unit 40, a control panel 50, a waveform generator unit 60, a DC power regulator unit 70 and a brake unit 80. In an embodiment, the electric power generation and brake device 100 is installed to a pedal fitness equipment 1000. It is noteworthy that the electric power generation and brake device 100 may also be installed to other assemblies.

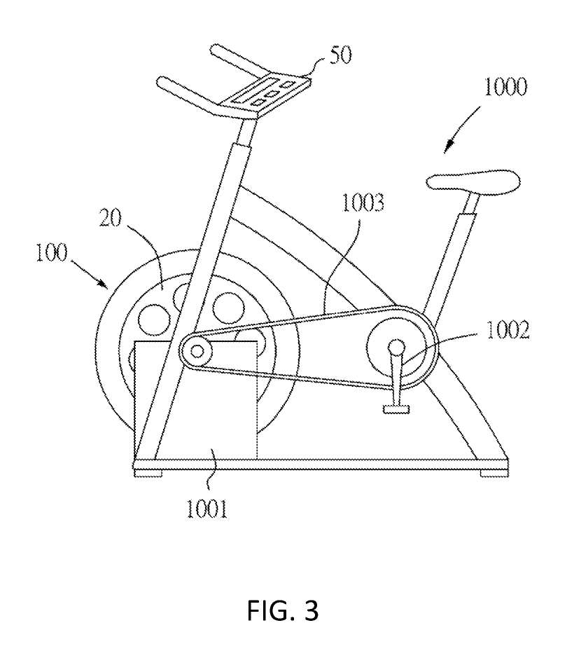

In FIGS. 2 and 3, the shaft 10 is axially installed to a base 1001 of the pedal fitness equipment 1000.

The wheel 20 is movably and axially installed to the shaft 10, and the wheel 20 comprises an outer ring 21, a plurality of permanent magnets 22 and an inner ring 23. The outer ring 21 is disposed around the edge of the wheel 20, and the permanent magnets 22 are spaced with each other and disposed on one surface of the outer ring 21 facing towards the axis of the wheel 20. The inner ring 23 and the outer ring 21 are coaxially installed to the wheel 20, and the inner ring 23 is disposed between the outer ring 21 and the axis of the wheel 20.

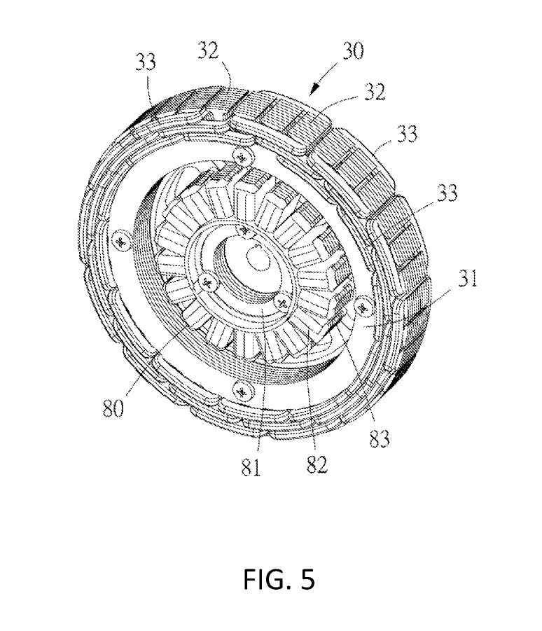

In FIGS. 2 to 5, the stator unit 30 is fixed to the shaft 10 by using the axis of the wheel 20 as the center, and the stator unit 30 comprises a stator body 31, a plurality of first serrated portions 32 and a plurality of electric generating coils 33. The stator body 31 is disposed between the outer ring 21 and the inner ring 23 of the wheel 20, and the first serrated portions 32 are disposed around an outer peripheral surface of the stator body 31, and the first serrated portions 32 are configured to be corresponsive to the permanent magnets 22 respectively. The electric generating coils 33 are wound around the first serrated portions 32. When the wheel 20 rotates, the permanent magnets 22 rotate with respect to the stator unit 30 to generate an alternating current.

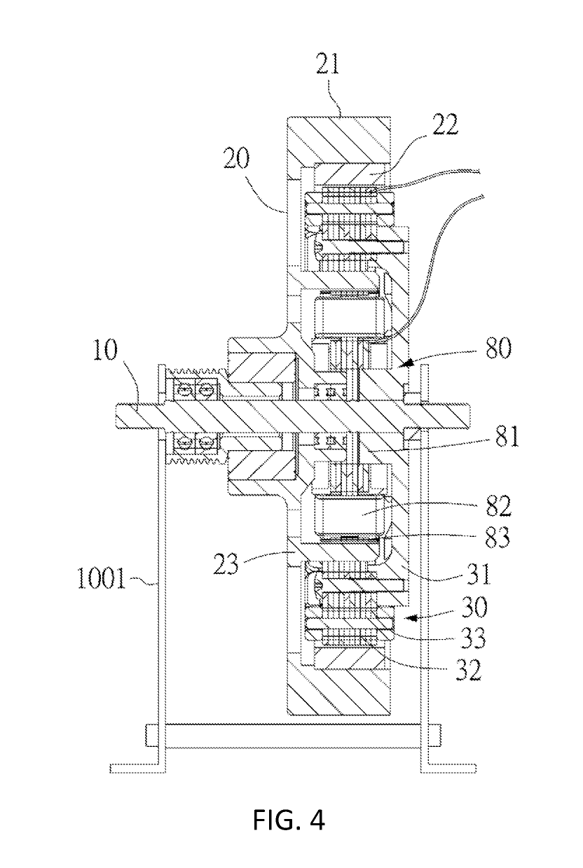

As shown in FIG. 2 and FIG. 4, an embodiment of the present invention, both of the outer ring 21 and the inner ring 23 are formed from extending the body of the wheel 20, and the first serrated portions 32 are accommodated between the outer ring 21 and the inner ring 23. Furthermore, in embodiment of the present invention, the wheel 20 comprises a plurality of through holes 24 between the outer ring 21 and the inner ring 23 that correspond to the electric generating coils 33, for accelerating the heat dissipation.

Moreover, in embodiment of the present invention, as shown in FIG. 2, the stator body 31 is provided with a plurality of through holes 34 between the axis and the first serrated portions 32. In addition, the through holes 34 of the stator body 31 are configured to correspond to the brake coils 83 while the brake unit 80 and the stator body 31 are assembled.

The rectifier unit 40 is electrically coupled to the stator unit 30 for converting the alternating current into a direct current. The control panel 50 is electrically coupled to the rectifier unit 40 and provided for a user to make an external operation to control the pedal fitness equipment 1000. The waveform generator unit 60 is electrically coupled to the control panel 50 for generating an inverted torque input signal according to the receiving direct current from the control panel 50 under the condition of the external operation. The DC power regulator unit 70 is electrically coupled to the waveform generator unit 60. The DC power regulator unit 70 receives the direct current from the control panel 50 under the condition of the external operation passed by the waveform generator unit 60 and receives the inverted torque input signal. The DC power regulator unit 70 further electrically connected to the brake coils 83 of the brake unit 80 to transmit the direct current and the inverted torque input signal to the brake coils 83. The rectifier unit 40, the waveform generator unit 60 and the DC power regulator unit 70 may be integrated as a controller module.

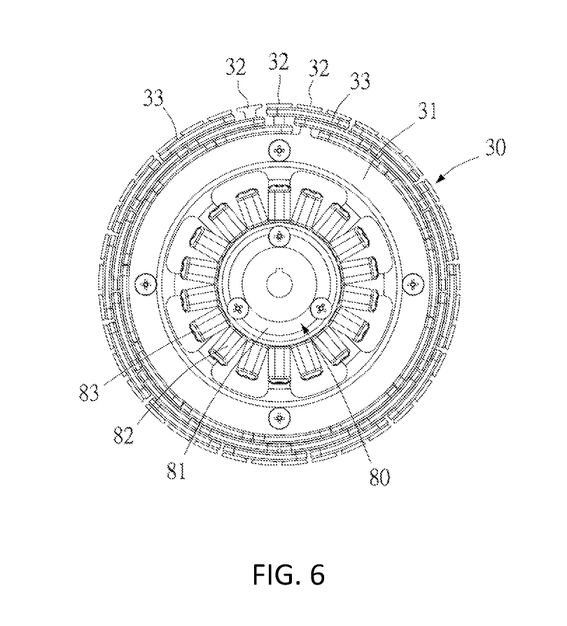

In FIGS. 2 to 6, the brake unit 80 is fixed to the stator body 31 by using the axis of the wheel 20 as the center, and the brake unit 80 is electrically coupled to the DC power regulator unit 70 for receiving the direct current and the inverted torque input signal. The brake unit 80 comprises a brake body 81, a plurality of second serrated portions 82 and a plurality of brake coils 83. The brake body 81 is disposed between the inner ring 23 of the wheel 20 and the axis of the wheel 20. The second serrated portions 82 are disposed around an outer peripheral surface of the brake body 81 and facing the inner ring 23, and the second serrated portions 82 are also configured to be corresponsive to the inner ring 23 of the wheel 20. The brake coils 83 are wound around the second serrated portions 82 respectively. After the brake unit 80 receives the direct current and the inverted torque input signal, a reverse torque (which is a force in the tangential direction) and an electromagnetic attraction force (which is a force in the radial direction) are generated to brake the wheel 20. It is noteworthy that the reverse torque is a force mainly used for braking the wheel 20 and the electromagnetic attraction force is a force mainly uses for assisting to brake the wheel 20. In addition, in other embodiment of the present invention, the brake unit 80 may be fixed to the shaft 10 (which is not shown in the figures).

Refer to FIGS. 2 to 4 again. The operation of the electric power generation and brake device 100 is described below.

Firstly, a user may step on a pedal unit 1002 (such as a pedal) of the pedal fitness equipment 1000 to drive the wheel 20 to rotate by a driving member 1003 (such as a belt), while the stator unit 30 and the brake unit 80 are remaining still.

When the wheel 20 is driven by the driving member 1003 to rotate, the permanent magnets 22 of the wheel 20 have effects on the first serrated portions 32 of the stator unit 30 and the electric generating coils 33 to generate the alternating current. The alternating current is transmitted to the rectifier unit 40 through an electric wire. The rectifier unit 40 converts the alternating current into the direct current. The direct current is transmitted to the control panel 50 and the DC power regulator unit 70 through an electric wire and the electric power is supplied to the control panel 50, so that the user may operate the control panel 50 to generate a control signal. The control signal transmitted from the control panel 50 is further transmitted to the waveform generator unit 60 through an electric wire to generate an inverted torque input signal. The inverted torque input signal generated from the waveform generator unit 60 and the direct current transmitted to the waveform generator unit 60 are further transmitted to the DC power regulator unit 70 through an electric wire, and then a regulatory direct current regulated by the DC power regulator unit 70 under the inverted torque input signal is transmitted to the brake unit 80. Thus, the brake unit 80 generates a reverse torque and an electromagnetic attraction force.

Since the brake body 81 of the brake unit 80 is installed in the stator body 31 of the stator unit 30 and configured to be corresponsive to the inner ring 23 of the wheel 20, therefore the reverse torque and the electromagnetic attraction force generated by the brake unit 80 may be used to control the rotation speed of the wheel 20 when the inner ring 23 of the wheel 20 is braked, so as to resist the vibration produced when the wheel 20 and the stator unit 30 are operated, and reduce the electromagnetic noise.

To reduce the significance of the cogging torque, the electric power generation and brake device 100 of the present invention includes a total of 12 magnetic poles of the permanent magnets 22 of the wheel 20, and the stator unit 30 includes a total of 37 first serrated portions 32. As described in the previous paragraph, the vibration can be resisted and the electromagnetic noise can be reduced since the brake body 81 of the brake unit 80 is installed in the stator body 31 of the stator unit 30 and configured to be corresponsive to the inner ring 23 of the wheel 20. Regardless of the permanent magnets 22 and the first serrated portions 32 being arranged in pairs, the effects of resisting vibration and reducing electromagnetic noise can be achieved.

Since the second serrated portions 82 of the brake unit 80 are configured on the outer peripheral surface of the brake body 81 and arranged symmetrically with respect to the center of the brake body 81, therefore the reverse torque and the electromagnetic attraction force generated by the brake unit 80 are uniform and symmetric, so as to improve the effect for the brake unit 80 to resist vibrations produced during the operation of the wheel 20 and the stator unit 30. Wherein, the brake unit 80 has a total of 18 second serrated portions 82.

In summation of the description above, the electric power generation and brake device of the present invention effectively utilizes the electric power generated by the stator unit in the control panel and the brake unit to avoid unnecessary waste of power. In addition, the stator unit and the brake unit are configured to resist the vibrations produced during the operation of the wheel and the stator unit, so as to reduce electromagnetic noise.

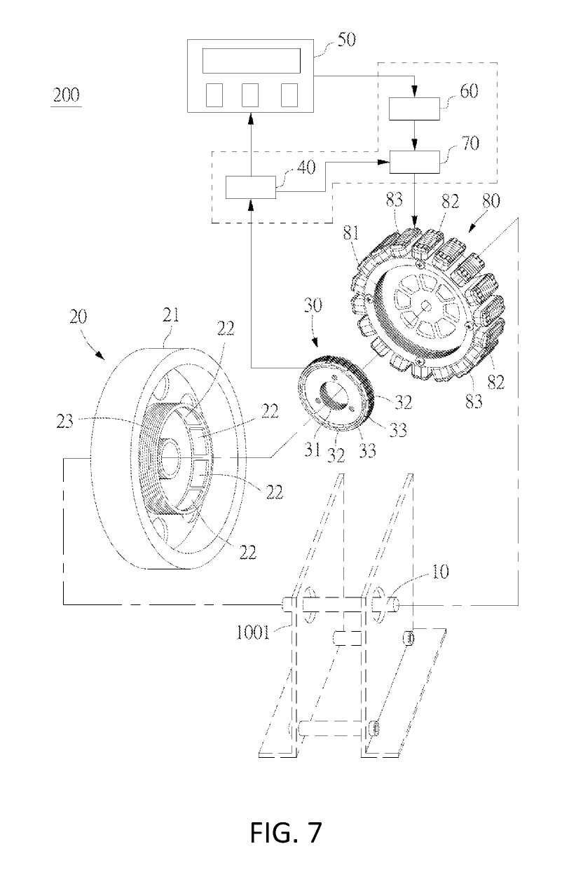

With reference to FIG. 7 for a schematic view of an electric power generation and brake device 200 in accordance with the second preferred embodiment of the present invention, the electric power generation and brake device 200 includes the same components as those of the electric power generation and brake device 100, except that the configuration and relation of the wheel 20, the stator unit 30 and the brake unit 80 are different from those of the first preferred embodiment.

Wherein, the electric power generation and brake device 200 comprises a shaft 10, a wheel 20, a stator unit 30, a rectifier unit 40, a control panel 50, a waveform generator unit 60, a DC power regulator unit 70 and a brake unit 80. The shaft 10 is axially installed to a base 1001 of the pedal fitness equipment.

The wheel 20 is movably and axially installed to the shaft 10, and the wheel 20 comprises an outer ring 21, a plurality of permanent magnets 22 and an inner ring 23. The outer ring 21 is disposed around the edge of the wheel 20. The inner ring 23 and the outer ring 21 are coaxially installed to the wheel 20, and disposed between the outer ring 21 and the axis of the wheel 20. The permanent magnets 22 are spaced with each other and disposed on a side of the inner ring 22 facing towards the axis of the wheel 20.

The stator unit 30 is fixed to the shaft 10 by using the axis of the wheel 20 as the center, and the stator unit 30 comprises a stator body 31, a plurality of first serrated portions 32 and a plurality of electric generating coils 33. The stator body 31 is disposed between the inner ring 23 of the wheel 20 and axis of the wheel 20. The first serrated portions 32 are disposed around the edge of the stator body 31, and the first serrated portions 32 are configured to be corresponsive to the permanent magnets 22 respectively. The electric generating coils 33 are wound around the first serrated portions 32. When the wheel 20 rotates, the permanent magnets 22 rotate with respect to the stator unit 30 to generate an alternating current.

The rectifier unit 40 is electrically coupled to the stator unit 30 for converting the alternating current into a direct current. The control panel 50 is electrically coupled to the rectifier unit 40. The waveform generator unit 60 is electrically coupled to the control panel 50 for generating an inverted torque input signal. The DC power regulator unit 70 is electrically coupled to the waveform generator unit 60. The rectifier unit 40, the waveform generator unit 60 and the DC power regulator unit 70 may be integrated as a controller module.

The brake unit 80 is fixed to the stator body 31 by using the axis of the wheel 20 as the center, and the brake unit 80 is electrically coupled to the DC power regulator unit 70 for receiving a regulatory direct current regulating under the inverted torque input signal. The brake unit 80 comprises a brake body 81, a plurality of second serrated portions 82 and a plurality of brake coils 83. The brake body 81 is disposed between the outer ring 21 and the inner ring 23 of the wheel 20. The second serrated portions 82 are disposed around the edge of the brake body 81, and the second serrated portions 82 are configured to be corresponsive to the outer ring 21 of the wheel 20. The brake coils 83 are wound around the second serrated portions 82 respectively. After the brake unit 80 receives the regulatory direct current, a reverse torque (which is a force in the tangential direction) and an electromagnetic attraction force (which is a force in the radial direction) are generated to brake the wheel 20. It is noteworthy that the reverse torque is a force mainly used for braking the wheel 20 and the electromagnetic attraction force is a force mainly uses for assisting to brake the wheel 20. In addition, the brake unit 80 may be fixed to the shaft 10 (which is not shown in the figure).

When the wheel 20 rotates, the permanent magnets 22 of the wheel 20 have effects on the first serrated portions 32 of the stator unit 30 and the electric generating coils 33 to generate the alternating current. The alternating current is transmitted to the rectifier unit 40 through an electric wire. The rectifier unit 40 converts the alternating current into the direct current. The direct current is transmitted to the control panel 50 and the DC power regulator unit 70 through an electric wire and the electric power is supplied to the control panel 50, so that the user may operate the control panel 50 to generate a control signal. The control signal transmitted from the control panel 50 is further transmitted to the waveform generator unit 60 through an electric wire to generate an inverted torque input signal. The inverted torque input signal generated from the waveform generator unit 60 is further transmitted to the DC power regulator unit 70 through an electric wire and then a regulatory direct current regulated by the DC power regulator unit 70 under the inverted torque input signal is transmitted to the brake unit 80. Thus, the brake unit 80 generates a reverse torque and an electromagnetic attraction force.

Since the brake body 81 of the brake unit 80 is configured to be corresponsive to the outer ring 21 of the wheel 20, therefore the reverse torque and the electromagnetic attraction force generated by the brake unit 80 may be used to control the rotation speed of the wheel 20 when the outer ring 21 of the wheel 20 is braked, so as to resist the vibration produced when the wheel 20 and the stator unit 30 are operated, and reduce the electromagnetic noise.

Since the second serrated portions 82 of the brake unit 80 are arranged symmetrically with respect to the center of the brake body 81, therefore the reverse torque and the electromagnetic attraction force generated by the brake unit 80 are uniform and symmetric, so as to improve the effect for the brake unit 80 to resist vibrations produced during the operation of the wheel 20 and the stator unit 30. In this way, the electric power generation and brake device 200 has the same effects as the electric power generation and brake device 100.

While the invention has been described by means of specific embodiments, numerous modifications and variations could be made thereto by those skilled in the art without departing from the scope and spirit of the invention set forth in the claims.

What is claimed is:

1. An electric power generation and brake device, disposed on a shaft, comprising:
a wheel, movably and axially installed on the shaft, comprising:
an outer ring, disposed around an edge of the wheel;
an inner ring, disposed coaxially with the outer ring on the wheel, and configured between the outer ring and an axis of the wheel; and
a plurality of permanent magnets, configured on one surface of the outer ring and facing the axis of the wheel;
a stator unit, comprising:
a stator body, fixedly disposed on the shaft;
a plurality of first serrated portions, disposed around an outer peripheral surface of the stator body and facing the permanent magnets; and
a plurality of electric generating coils, wound around the first serrated portions; and
a brake unit, comprising:
a brake body, fixed on the shaft or the stator body, configured between the inner ring and the axis of the wheel;
a plurality of second serrated portions, disposed around an outer peripheral surface of the brake body and facing the inner ring; and
a plurality of brake coils, wound around the second serrated portions.

2. The electric power generation and brake device according to claim 1, wherein both of the outer ring and the inner ring are formed from extending the body of the wheel, and the first serrated portions are accommodated between the outer ring and the inner ring.

3. The electric power generation and brake device according to claim 2, wherein the wheel comprises a plurality of through holes between the outer ring and the inner ring that correspond to the electric generating coils.

4. The electric power generation and brake device according to claim 1, wherein the stator body is provided with a plurality of through holes between the axis and the first serrated portions.

5. The electric power generation and brake device according to claim 4, wherein the through holes of the stator body correspond to the brake coils.

6. The electric power generation and brake device of claim 1, further comprising:
a rectifier unit, electrically connected to the stator unit, converting an alternating current generated by the stator unit to a direct current, wherein, when the wheel rotates, the permanent magnets rotate with respect to the stator unit to generate the alternating current;
a control panel, electrically connected to the rectifier unit to receive the direct current;
a waveform generating unit, electrically connected to the control panel to receive the direct current, generating an inverted torque input signal according to an external operation on the control panel; and
a DC power regulator unit, electrically connected to the waveform generating unit to receive the direct current and the inverted torque input signal, further electrically connected to the brake coils of the brake unit to transmit a regulatory direct current regulating under the inverted torque input signal to the brake coils.

7. The electric power generation and brake device according to claim 1, wherein the permanent magnets of the wheel have a total of 12 magnetic poles, and the stator unit has a total of 37 first serrated portions.

8. The electric power generation and brake device according to claim 7, wherein the second serrated portions of the brake unit have a total of 18 second serrated portions.

9. The electric power generation and brake device according to claim 8, wherein the second serrated portions are configured on the outer peripheral surface of the brake body and are symmetrically arranged relative to a center of the brake body.

10. The electric power generation and brake device according to claim 1, wherein the second serrated portions are configured on the outer peripheral surface of the brake body and are symmetrically arranged relative to a center of the brake body.

11. The electric power generation and brake device according to claim 1, wherein the wheel, the stator unit and the brake unit are configured in a base of a pedal exercise apparatus; the pedal exercise apparatus comprises a pedal unit in the base, and the wheel is driven by a driving member of the pedal unit to rotate on the shaft; the electric generating coils are caused, through rotation of the permanent magnets of the wheel relative to the stator unit, to generate an electric current; and the current generated causes, by an external operation, the brake coils of the brake unit to receive at least a part of the electric current to further cause a force for actuating the wheel.

12. The electric power generation and brake device according to claim 11, wherein both of the outer ring and the inner ring are formed from extending the body of the wheel, and the first serrated portions are accommodated between the outer ring and the inner ring.

13. The electric power generation and brake device according to claim 12, wherein the wheel comprises a plurality of through holes between the outer ring and the inner ring that correspond to the electric generating coils.

14. The electric power generation and brake device according to claim 11, wherein the stator body is provided with a plurality of through holes between the axis and the first serrated portions.

15. The electric power generation and brake device according to claim 14, wherein the through holes of the stator body correspond to the brake coils.

16. The electric power generation and brake device of claim 11, further comprising:
a rectifier unit, electrically connected to the stator unit, converting an alternating current generated by the stator unit to a direct current, wherein, when the wheel rotates, the permanent magnets rotate with respect to the stator unit to generate the alternating current;
a control panel, electrically connected to the rectifier unit to receive the direct current;
a waveform generating unit, electrically connected to the control panel to receive the direct current, generating an inverted torque input signal according to the external operation on the control panel; and
a DC power regulator unit, electrically connected to the waveform generating unit to receive the direct current and the inverted torque input signal, further electrically connected to the brake coils of the brake unit to transmit a regulatory direct current regulating under the inverted torque input signal to the brake coils.
